(19) United States
(12) Patent Application Publication
(10) Pub. No.: US 2002/0156933 A1
(43) Pub. Date: Oct. 24, 2002

(54) Communication service for transmitting events between software independently of applications

(76) Inventors: Laurent Philippe Anquetil, Paris (FR); Alberto Conte, Paris (FR)

Correspondence Address: Sughrue Mion Zinn, Macpeak & Seas, Suite 800, 2100 Pennsylvania Avenue NW, Washington, DC, 20037-3213, US

(21) Appl. No.: 09/958,603

(22) PCT Filed: Feb. 13, 2001
(86) PCT No.: PCT/FR01/00415

(30) Foreign Application Priority Data
Feb. 14, 2000 (FR) 00 01 808

(51) Int. Cl. G06F 9/46

(52) U.S. Cl. 709/318

(57) ABSTRACT

A communication service enabling events to be forwarded from at least one data producer to at least one data consumer, the service being characterized it that it comprises a distributor module and a set of filter modules, said distributor module possessing means for receiving said events and for forwarding them to said set of filter modules, and each filter module in said set having means for receiving said events, for filtering them in application of a respective filter mechanism, and for forwarding them to certain ones of said at least one data consumer.

The present invention relates to communication between software components of a software application.

Very often, software applications are designed with little provision for future development. Under such circumstances, they are often monolithic, i.e. they are formed by a single software component, or by a plurality of software components, but with no attempt being made to ensure that these software components are independent of one another. In other words, each component of the software application is designed for the purpose of being an integral portion of the software application.

Nevertheless, it is known that attempts can be made to ensure that each of the software components is independent of the others. To do this, coupling between the various components constituting the application is reduced by establishing well-specified interfaces between them together with communication mechanisms enabling them to interchange information.

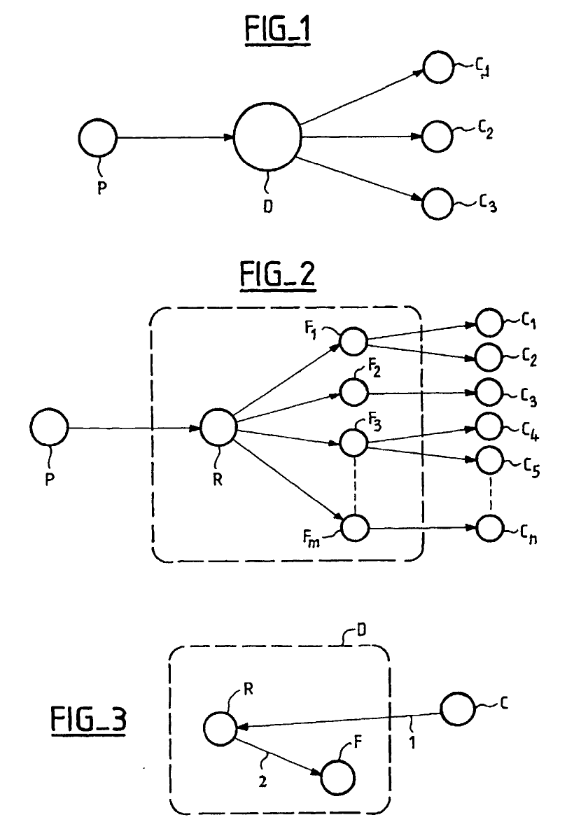

FIG. 1 illustrates such a mechanism. That mechanism is described in the work by Erich Gamma, Richard Helm, Ralph Johnson, and John Vlissides, “Design patterns—elements of reusable object-oriented software”, published by Addison-Wesley (5th edition, 1995).

According to that document, the software components of a given application (or possibly of a plurality of applications) interchange messages via a communication service D generally referred to as a dispatcher or a dispatching event service. Each software component can be considered as producing data P or as consuming data C₁, C₂, C₃ (referred to as an “observer” in that work).

Naturally, in practice, any given software component can possess both roles, i.e. it can both be a producer of data and a consumer of data. Nevertheless, in the interest of clarity, the explanation is restricted to software components having either a data-producing role or a data-consuming role.

In general, the data is structured in the form of events, i.e. as messages that are issued asynchronously, complying with a well-specified format.

In that state of the art, the data consumers C₁, C₂, and C₃ need to register with the communication service D, specifying the types of event they seek to receive. Similarly, data producers P issue events to the communication service D without worrying about their final destinations: thus, destination handling is delegated to the communication service D.

As a result, each time a data producer P issues an event to the communication service D, it is up to the communication service to determine which data consumers are to receive the event, as a function of information which the data consumers specified on registering.

Unfortunately, that solution is not satisfactory.

The main problem results from the fact that handling of the filtering and routing of events is dedicated to the communication service which lies outside the application.

More precisely, that requires the communication service to be aware of the internal functioning of the application, even though it is itself external thereto. In order to be able to route events to the appropriate data consumer, the communication service must implement the event-routing policy that is desired by the application. Consequently, the split between that which is specific to the application and that which is not specific to the application is poor and the overall system lacks flexibility.

Furthermore, the communication server D must be capable of interpreting the events that reach it from the data producers P in order to be able to determine which data consumers C are to receive the data, on the basis of information previously supplied by the consumers.

In the prior art, this can be done in two different ways.

In a first solution, each type of event is implemented in the form of a different class. The term “class” is used here in the object-oriented programming sense. Correspondingly, data consumers register with the communication server for one or more classes.

Thus, by determining the class of an event received from a data producer, the communication server can determine the data consumers to which it must route the event it has received.

A first drawback of acting in that way is that filtering cannot be very fine since the nature of the data contained in an event is not analyzed.

Another drawback it that it requires numerous classes of event to be created, which makes it quite complex to implement.

Another way of proceeding thus consists in the communication server analyzing the data contained in the events it receives. Depending on the information provided by the data consumers, the communication server can determine the data consumers to which it is to route a received event. To be able to do this it must know how data is structured within events. Since data structures depend on applications, that means that the communication server must have in-depth knowledge of the internal mechanisms of the various applications that make use of its services.

Consequently, acting in that way involves a loss of independence for the communication server relative to applications, and means that the communication server becomes very complex.

Prior art solutions are therefore not very satisfactory. The object of the present invention is to enable events to be communicated between one or more data producers and one or more data consumers via a communication server that is independent of the applications and that provides good filtering performance.

To do this, the invention provides a communication service enabling events to be transferred from at least one data producer to at least one data consumer. The communication service is characterized in that it comprises a distributor module and a set of filter modules, which set might possibly be constituted by a singleton. The distributor module possesses means for receiving events and for forwarding them to the set of filter modules, and each of the filter modules in the set has means for receiving them, for filtering them in application of a respective filter mechanism, and for forwarding them to certain data consumers.

In this manner, each software application can specify to the communication service which filter module it desires to use. The filter modules can then be specific to an application (or at least to a given type of application) and can implement filter methods that require the data contained in the event to be analyzed, while nevertheless ensuring that the communication server continues to be generic since it is only the filter modules that are application-specific.

As can be understood by the person skilled in the art, the various means available to the filter modules and the distributor module can be implemented by execution threads. In other words, the filter modules and the distributor module can be executed in parallel and in independent manner.

The invention also provides a method enabling a data consumer to register with such a communication service. This method comprises:

A first step consisting in the data consumer sending a registration message to the distributor module. The message contains information concerning a filter mechanism.

A second step consisting in the distributor module sending to a filter module determined by said information, information relating to the data consumer so as to enable it to be registered.

In an implementation of the invention, the filter modules can be added by applications, in particular in dynamic manner, i.e. during the lifetime of the system without stopping it.

The invention thus also provides a method enabling the communication service to be used by a data consumer. This method comprises:

a first step consisting in the consumer sending to the distributor module a message containing information relating to at least one filter module;

a second step consisting in the distributor module forwarding events to the filter module(s); and

a third step consisting in the filter module(s) filtering said event and then forwarding them to the data consumer.

Other characteristics and advantages of the invention will appear more clearly in the following description made with reference to the accompanying figures.

FIG. 1, described above, illustrates a prior art architecture for a communication server.

FIG. 2 is a diagram of a communication server in accordance with the present invention.

FIG. 3 illustrates the method whereby a new filter module is registered with the communication server.

The communication service, referenced D in FIG. 2, is constituted firstly by a first software element referred to below as the distributor module and referenced R, and secondly by a set of software modules referred to as filter modules and referenced F₁, F₂, F₃, . . . , Fₘ where m is the number of such filter modules.

The distributor R receives events from one or more data producers P. On receiving them, it forwards them directly to the filter modules, without analyzing them.

The filter modules F₁ to Fₘ have means for analyzing the data contained in the events. Each of them can implement a different filter mechanism. Depending on the analysis they perform and the filter mechanisms they implement, the filter modules then determine, for each received event, whether or not it needs to be forwarded. When an event is not filtered-out (i.e. when it is to be forwarded), it is forwarded to those data consumers C₁, C₂, C₃, . . . , Cₙ, which have registered with the filter module in question.

Unlike the prior art solutions, there is no need here to determine a subset of data consumers to which events are to be forwarded after filtering: events are forwarded to all of the data consumers registered with any given filter module. It will be understood that the filter module structure, and a fortiori, the structure of the communication service overall, is thereby simplified.

FIG. 3 represents the mechanism implemented when a software application wishes to register with the communication service.

From the point of view of the communication service, a software application can be considered as a set of data consumers and data producers.

Thus, when an application desires to use the communication service, it needs to proceed with registering a certain number of software elements as data consumers with said communication service.

This registration mechanism is illustrated by FIG. 3.

In a step represented by arrow 1, the data consumer C registers with the communication service D by sending a registration message to the distributor module R. This registration message contains information relating to the desired filter mechanism, and in particular it can contain an identifier of the filter module which is to be used. By way of example, this identifier is a pointer or an address.

The information can also contain parameters of the filter mechanism (e.g. a sorting criterion).

Finally, the information supplied by the registration message contains an identifier of the data consumer C.

Thereafter, in a step represented by arrow 2, the distributor module R forwards the identifier of the data consumer as received in the preceding step to the filter module F as determined by the information supplied by the data consumer.

In addition, the distributor module R can also forward other information to the filter module F, in particular any parameters that might have been supplied by the data consumer.

The filter module F can then store all of said information. In the invention, provision can be made for the filter module F to include storage means (e.g. a memory zone organized as a table) listing all of the data consumers C that have registered with it in this way.

Thus, when the filter module receives an event from the distributor module R, it is in a position to forward the event to that set of data consumers, possibly after taking account of any specific parameters that might be associated with them.

When an application seeks to use the communication service, it can, prior to registering data consumers, begin by registering one or more filter modules. It can also register filter modules even after it has begun to use the communication service.

To do this, the application, in particular via the data consumers, can send a message to the distributor module. The message can contain information relating to the filter module, and in particular an identifier (a pointer, an address, . . . ). The distributor module thus possesses means for receiving such messages, and means for adding the new filter module to the set of filter modules that it manages.

More precisely, the distributor module can possess storage means enabling it to list the set of filter modules (by means of their identifiers), optionally associating them with parameters.

Each time the distributor module receives an event from a data producer, it is thus in a position, with the help of said memory means, to forward the event to the set of filter modules

1/ A communication service (D) enabling events to be forwarded from at least one data producer (P) to at least one data consumer (C₁, C₂, C₃, . . . , Cₙ), the service being characterized it that it comprises a distributor module (R) and a set of filter modules (F₁, F₂, F₃, . . . , Fₘ), said distributor module possessing means for receiving said events and for forwarding them to said set of filter modules, and each filter module in said set having means for receiving said events, for filtering them in application of a respective filter mechanism, and for forwarding them to certain ones of said at least one data consumer.

2/ A communication service according to the preceding claim, in which each of the filter modules of said set possesses means for establishing its own filter mechanism as a function of information forwarded by said at least one data consumer to said communication service.

3/ A communication service according to either one of the preceding claims, in which each of the filter modules of said set possesses means for storing the data consumers to which it is to forward said event.

4/ A communication service according to any preceding claim, characterized it that said distributor module possesses means for receiving a message from said at least one data consumer, the message containing information relating to a new filter module, and to add said new filter module to said set of filter modules.

5/ A method of registering a data consumer with a communication service (D), said communication service comprising a distributor module (R) and a set of filter modules (F), said method comprising:
a first step (1) consisting in said data consumer (C) sending a registration message to said distributor module (4), the message containing information relating to a filter mechanism; and
a second step (2) consisting in said distributor module sending to a filter module determined from said information relating to a filter mechanism information relating to said data consumer (C) enabling the data consumer to be registered.

6/ A method whereby a data consumer (C) uses a communication service (D) comprising at least a distributor module (R) suitable for receiving events, said method comprising:
a first step consisting in said data consumer sending a message containing information relating to at least one filter module (F) to said distributor module (R);
a second step consisting in the distributor module (D) forwarding said events to said at least one filter module; and
a third step consisting in said at least one filter module filtering said events and then forwarding them to said data consumer.
